(19) United States
(12) Patent Application Publication
(10) Pub. No.: US 2023/0307736 A1
(43) Pub. Date: Sep. 28, 2023

(54) Method for Direct Recycling of Cathode Active Material in Cathode Electrode Foil Scrap in Li-Ion Battery Manufacturing

(71) Applicants: Jongmoon Yoon, Mission Viejo, CA (US); Seokwon Kim, Mission Viejo, CA (US); Shinjin Choi, Mission Viejo, CA (US)

(72) Inventors: Jongmoon Yoon, Mission Viejo, CA (US); Seokwon Kim, Mission Viejo, CA (US); Shinjin Choi, Mission Viejo, CA (US)

(21) Appl. No.: 18/317,102

(22) Filed: May 15, 2023

(51) Int. Cl. H01M 10/54; H01M 10/0525; H01M 4/58; H01M 4/525; H01M 4/505

(52) U.S. Cl. CPC H01M 10/54; H01M 10/0525; H01M 4/5825; H01M 4/525; H01M 4/505; H01M 2004/028

(57) ABSTRACT

The invention relates to a method for recycling cathode electrode foil scrap in the manufacturing of Li-Ion batteries, with a focus on the direct recycling of cathode active material to avoid the generation of LiF (lithium fluoride) layer on the surface of cathode active material particles. The LiF layer is known to cause increased electric resistance of the active cathode material, leading to poor electrochemical properties and reduced efficiency and performance of the recycled cathode active materials. To address this issue, the invention proposes the use of defluorination agents, such as a mixture of Ca(OH)2 and CaO, during the recycling process to effectively eliminate polymer binders while avoiding LiF generation, resulting in high-quality recycled materials.

### PRIOR ART

Existing methods for recycling cathode electrode foil scrap in Li-Ion battery manufacturing involve heating the foil to high temperatures (˜500° C.) to carbonize the organic binder in an air or N2 inert atmosphere.

However, during the decomposition of the organic binder through carbonization, fluorine in the organic binders reacts with lithium from the surface of cathode active materials, resulting in the generation of a LiF layer on the surface of cathode active material particles.

The LiF layer causes increased electric resistance of the active cathode material.

Additionally, the consumption of lithium from the cathode active material during the binder removal process leads to changes in the surface crystal structure of the active cathode material, resulting in poor electrochemical properties in terms of available lithium contents and reversible Li-ion transfer.

These issues can reduce the overall efficiency and performance of the recycled cathode active materials, limiting their potential for reuse in battery manufacturing processes.

### BACKGROUND OF THE INVENTION

Due to the increasing electrification in automotive and renewable energy generation, there is an expected rise in Li-ion battery production, resulting in considerable amounts of battery production scraps and spent batteries. Recycling of these side products is necessary to avoid environmental pollution and conserve rare earth materials.

However, traditional recycling methods involve melting or dissolving active battery materials into raw chemical materials, which requires a significant amount of energy and water to manage toxic chemical wastes, resulting in additional greenhouse gas emissions and water usage. This approach may not be environmentally friendly.

To minimize energy consumption, toxic waste, and environmental pollution in battery recycling, there is a need for a process that can extract active battery materials from electrode-coated foils without melting or dissolving them into raw chemical materials. If active battery materials can be extracted without melting or dissolving to the atomic level, it could potentially result in lower greenhouse gas emissions, no toxic waste, and no polluted chemical side-products.

One of the methods for extracting active battery materials is regenerating active cathode materials from spent batteries or battery plant scraps, without melting or dissolving the battery electrode at the atomic level. This approach has the potential advantage of lower greenhouse gas emissions, no toxic waste, and no polluted chemical side-products compared to traditional pyro or hydrometallurgical approaches.

However, one of the challenges in the regeneration process is recovering the electrochemical performance and properties of pure battery active material. Additionally, the cathode-coated foil contains PVDF or PTFE, which are polymers that bind the active and electric conducting materials together and provide adhesion on the conducting metal foil of the battery electrode.

In the binding polymers of battery electrodes, fluorine is present, and it quickly reacts with lithium from the cathode active material and excess lithium on the cathode surface to generate LiF when the binding polymers are eliminated by heating the cathode-coated foils (at around 400-500° C.). The generation of LiF on the surface of active cathode materials is inevitable due to the high oxidation strength of fluorine. However, LiF has high electric resistance, resulting in higher electric resistance of recycled cathode active materials from cathode-coated foils after heating to eliminate binding polymers. This renders the recycled cathode active materials unsuitable for use as active battery materials due to their high electric resistance caused by the generated LiF layer.

### SUMMARY OF THE INVENTION

The direct recycling of cathode-coated foil can be made practical by controlling LiF generation during the recycling process. LiF generation, which can occur during the decomposition of polymer binders, can cause issues such as decreased performance and safety concerns in recycled cathode active materials.

To effectively eliminate polymer binders while avoiding LiF generation, defluorination agents are added to the recycling process. These defluorination agents consist of a mixture of Ca(OH)2 and CaO, which play different roles in the process.

Ca(OH)2 acts as an early defluorination agent by initiating hydro-fluorination reactions at a lower temperature than the decomposition temperature of polymer binders. This lowers the energy required for decomposing polymer binders, resulting in energy savings and making the process more efficient.

CaO, on the other hand, has a higher degree of transforming fluorine to calcium fluoride compounds compared to Ca(OH)2. This means that the mixture of Ca(OH)2 and CaO as the defluorination agent provides optimal defluorination to avoid LiF generation on recycled cathode active material, ensuring high-quality recycled materials.

In addition to Ca(OH)2 and CaO, there are other defluorination agents that can potentially be used to address the issue of LiF generation during the recycling of cathode-coated foils. Some examples of alternative defluorination agents include:

Magnesium oxide (MgO): MgO is known to react with fluorine, forming magnesium fluoride (MgF2). It has a high melting point and can effectively defluorinate polymer binders at elevated temperatures, making it a potential defluorination agent for recycling cathode-coated foils;

Aluminum oxide (Al2O3): Al2O3, commonly known as alumina, is another compound that can react with fluorine to form aluminum fluoride (AlF3). Al2O3 is widely used in various high-temperature applications due to its thermal stability and can potentially be used as a defluorination agent in the recycling process; or,

Calcium carbonate (CaCO3): CaCO3, also known as limestone or chalk, is a readily available and inexpensive compound. It can decompose at high temperatures, releasing carbon dioxide (CO2) and leaving behind calcium oxide (CaO), which can react with fluorine to form calcium fluoride (CaF2). CaCO3 has been studied as a potential defluorination agent in some applications and may also be considered for recycling cathode-coated foils.

The effectiveness of these alternative defluorination agents may depend on various factors such as reaction conditions, temperature, duration, and the specific composition of the cathode-coated foils being recycled. Further research and testing may be needed to determine their suitability and efficiency in addressing the LiF generation issue in the recycling process. The current invention pertains to the adding of these potential defluorination agents to ensure high-quality recycled cathode active materials.

After adding the defluorination agent, the reaction products are calcium fluoride, which has a lower gravimetric density than cathode active material. This allows for easy separation of cathode active materials from carbonized binders and defluorination reaction products, facilitating the recycling process.

Furthermore, calcium fluoride compounds produced as a result of the defluorination reaction are safe and can be utilized for other purposes, adding to the overall viability and practicality of the direct recycling of cathode-coated foils as a sustainable solution for battery recycling.

Therefore, the solution involving the use of Ca(OH)2 and CaO as defluorination agents offers a promising approach to address the background issue and make the direct recycling of cathode-coated foils more practical and viable, with potential benefits in terms of energy savings, high-quality recycled materials, and utilization of reaction products for other purposes.

### BRIEF DESCRIPTION OF DRAWINGS

The accompanying flowchart illustrates the process of adding defluorination agents during the recycling process of cathode electrode scraps.

FIG. 1 is a diagram showing the overall process of recycling cathode active material from the cathode electrode scraps.

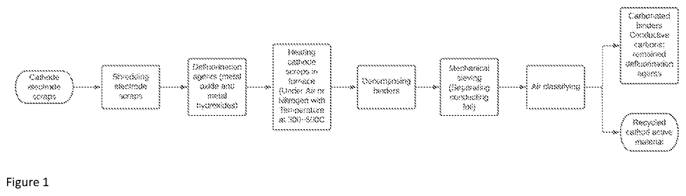

### DETAILED DESCRIPTION OF THE INVENTION

The present invention relates to the field of lithium-ion (Li-Ion) battery manufacturing and, more specifically, to a method for direct recycling of cathode active material in cathode electrode foil scrap in Li-Ion battery manufacturing, while addressing the issue of lithium fluoride (LiF) generation during the recycling process.

With the increasing electrification of automotive and renewable energy generation, there is a growing demand for Li-Ion batteries, resulting in a significant amount of battery production scraps and spent batteries. Recycling of these materials is necessary to avoid environmental pollution and conserve rare earth materials. However, traditional recycling methods involving melting or dissolving active battery materials into raw chemical materials require substantial energy and water, and can generate toxic waste, resulting in additional greenhouse gas emissions and environmental concerns.

To minimize energy consumption, toxic waste, and environmental pollution in battery recycling, there is a need for a process that can extract active battery materials from electrode-coated foils without melting or dissolving them into raw chemical materials. One approach is regenerating active cathode materials from spent batteries or battery plant scraps, without melting or dissolving the battery electrode at the atomic level, to potentially achieve lower greenhouse gas emissions, no toxic waste, and no polluted chemical side-products compared to traditional methods.

However, one of the challenges in the regeneration process is recovering the electrochemical performance and properties of pure battery active material, as the cathode-coated foil contains polymer binders that generate LiF on the surface of active cathode materials during the heating process. LiF has high electric resistance, which renders the recycled cathode active materials unsuitable for use in batteries due to decreased performance and safety concerns.

The present invention provides a method for direct recycling of cathode active material in cathode electrode foil scrap in Li-Ion battery manufacturing, while addressing the issue of LiF generation during the recycling process. The method involves adding defluorination agents to the recycling process, which consist of a mixture of Ca(OH)2 and CaO. Ca(OH)2 acts as an early defluorination agent by initiating hydro-fluorination reactions at a lower temperature than the decomposition temperature of polymer binders, resulting in energy savings and increased process efficiency. CaO, on the other hand, has a higher degree of transforming fluorine to calcium fluoride compounds compared to Ca(OH)2, providing optimal defluorination to avoid LiF generation on recycled cathode active material, ensuring high-quality recycled materials.

In addition to Ca(OH)2 and CaO, the invention also contemplates the use of other defluorination agents, such as magnesium oxide (MgO) and aluminum oxide (Al2O3), which can potentially be used to address the issue of LiF generation during the recycling of cathode-coated foils.

The method for direct recycling of cathode active material in cathode electrode foil scrap in Li-Ion battery manufacturing comprises several steps:

The first step involves the collection of cathode electrode foil scrap. Cathode electrode foil scrap is collected from the manufacturing process of Li-Ion batteries. The foil scrap may contain cathode active materials such as lithium cobalt oxide (LiCoO2), lithium nickel cobalt manganese oxide (LiNiCoMnO2), lithium manganese oxide (LiMn2O4), or other similar materials. The foil scrap may also contain polymer binders such as polyvinylidene fluoride (PVDF) or polytetrafluoroethylene (PTFE), which are commonly used in cathode electrodes for Li-Ion batteries.

The second step involves shredding electrode scraps and addition of defluorination agents. Defluorination agents are added to the cathode electrode foil scrap to effectively eliminate polymer binders while avoiding LiF generation. The defluorination agents used in the invention comprise a mixture of Ca(OH)2 and CaO, which play different roles in the recycling process. Ca(OH)2 acts as an early defluorination agent by initiating hydro-fluorination reactions at a lower temperature than the decomposition temperature of polymer binders. This lowers the energy required for decomposing polymer binders, resulting in energy savings and making the process more efficient. CaO, on the other hand, has a higher degree of transforming fluorine to calcium fluoride compounds compared to Ca(OH)2, providing optimal defluorination to avoid LiF generation on recycled cathode active material.

In addition to Ca(OH)2 and CaO, other defluorination agents can potentially be used in the method to address the issue of LiF generation during the recycling of cathode electrode foil scrap. Some examples of alternative defluorination agents include magnesium oxide (MgO) and aluminum oxide (Al2O3), which are known to react with fluorine, forming aluminum fluoride (AlF3). It has a high melting point and good thermal stability, which makes it suitable for use in high-temperature recycling processes.

The third step involves heating and decomposition of the binders. The cathode electrode foil scrap mixed with the defluorination agents is heated in a controlled environment, such as a furnace or a reactor, to a temperature below 500° C., which is the typical decomposition temperature of polymer binders in cathode electrode foil scrap. The heating process initiates the decomposition of the polymer binders, and the defluorination agents, particularly Ca(OH)2, facilitate the removal of fluorine from the binders by forming hydro-fluorination reactions. CaO further transforms fluorine to calcium fluoride compounds, effectively avoiding LiF generation on recycled cathode active material.

The fourth step involves separating of the conducting foil via mechanical sieving. After the heating and decomposition process, the resulting material is cooled and processed to recover the cathode active material. The recovered cathode active material is then subjected to further processing steps, such as sieving, milling, and/or mixing with fresh cathode active material, as needed, to obtain a high-quality recycled cathode active material suitable for reuse in Li-Ion battery manufacturing.

The direct recycling method described herein can be applied to various types of Li-Ion batteries, including but not limited to lithium cobalt oxide (LiCoO2), lithium nickel cobalt manganese oxide (LiNiCoMnO2), lithium manganese oxide (LiMn2O4), lithium iron phosphate (LiFePO4), and other cathode materials used in Li-Ion batteries. It can be implemented in different scales, ranging from small-scale recycling of laboratory samples to large-scale recycling in commercial battery manufacturing facilities.

In summary, the present invention provides a method for direct recycling of cathode active materials in cathode electrode foil scrap from Li-Ion battery manufacturing, using defluorination agents to effectively defluorinate polymer binders at lower temperatures without causing LiF generation. This method avoids the negative impact of LiF generation on the electrochemical properties of recycled cathode active materials, reduces energy consumption and environmental pollution, and promotes circular economy practices in the battery industry.

1. A method for direct recycling of cathode active materials in cathode electrode foil scrap from Li-Ion battery manufacturing, comprising: a) providing cathode electrode foil scrap containing cathode active materials and polymer binders; b) treating the cathode electrode foil scrap with a defluorination agent at a temperature below the generation of LiF to defluorinate the polymer binders; c) recovering the cathode active materials from the treated cathode electrode foil scrap; d) optionally, further treating the recovered cathode active materials with a surface coating treatment or heat-treatment under Oxygen atmosphere to enhance their surface structure stability; and e) reusing the recovered cathode active materials in the manufacture of new Li-Ion batteries.

2. The method of claim 1, wherein the defluorination agent is selected from the group consisting of alkali metal hydroxides, alkali metal carbonates, alkali metal bicarbonates, alkali metal phosphates, alkali metal sulfates, alkali metal silicates, alkali metal fluorides, and mixtures thereof.

3. The method of claim 1, wherein the defluorination agent is selected from the group consisting of sodium hydroxide, potassium hydroxide, sodium carbonate, potassium carbonate, sodium bicarbonate, potassium bicarbonate, sodium phosphate, potassium phosphate, sodium sulfate, potassium sulfate, sodium silicate, potassium silicate, and mixtures thereof.

4. The method of claim 1, wherein the temperature during the treatment with the defluorination agent is in the range of 100° C. to 300° C.

5. The method of claim 1, wherein the cathode active materials recovered from the treated cathode electrode foil scrap have a purity of at least 95%.

6. The method of claim 1, wherein the surface coating treatment comprises applying a protective layer made of lithium phosphate, lithium titanate, or other suitable materials to the recovered cathode active materials.

7. The method of claim 1, further comprising additional steps selected from the group consisting of sieving, magnetic separation, and other physical separation techniques to remove impurities and contaminants from the cathode electrode foil scrap.

8. The method of claim 1, wherein the cathode active materials are selected from the group consisting of lithium cobalt oxide (LiCoO2), lithium nickel cobalt manganese oxide (LiNiCoMnO2), lithium manganese oxide (LiMn2O4), and lithium iron phosphate (LiFePO4).

9. The method of claim 1, wherein the method is implemented in a commercial battery manufacturing facility for large-scale recycling of cathode active materials.

10. A recycled cathode active material obtained by the method of claim 1, wherein the recycled cathode active material has improved electrochemical properties due to the effective defluorination of polymer binders without generating LiF.
